(19) United States
(12) Patent Application Publication
(10) Pub. No.: US 2006/0072792 A1
(43) Pub. Date: Apr. 6, 2006

(54) Driver monitoring system for vehicle

(75) Inventors: Hiroshi Toda, Kariya-shi (JP); Kenichi Ogawa, Kariya-shi (JP); Kenichi Ohue, Toyota-shi (JP); Tomoo Kakegawa, Toyota-Shi (JP)

Correspondence Address: SUGHRUE MION, PLLC, 2100 PENNSYLVANIA AVENUE, N.W., SUITE 800, WASHINGTON, DC, 20037, US

(73) Assignee: AISIN SEIKI KABUSHIKI KAISHA

(21) Appl. No.: 11/237,978

(22) Filed: Sep. 29, 2005

(30) Foreign Application Priority Data
Sep. 29, 2004 (JP) 2004-284318

(51) Int. Cl. G06K 9/00

(52) U.S. Cl. 382/115

(57) ABSTRACT

A driver monitoring system for a vehicle includes an image capturing means for capturing an image of a driver's seat, and a controlling means for performing a face identification determination, and an inattentive and drowsy driving determination of a driver based on an image captured by the image capturing means, wherein the controlling means determines whether or not a driver on the driver's seat is a registered driver on the basis of an image captured by the image capturing means when a shifting means is in a parking position, and determines whether or not a driver is looking aside or falling asleep on the basis of an image captured by the image capturing means when the shifting means is in a shift position other than the parking position.

### CROSS REFERENCE TO RELATED APPLICATIONS

This application is based on and claims priority under 35 U.S.C. § 119 to Japanese Patent Application No. 2004-284318, filed on Sep. 29, 2004, the entire content of which is incorporated herein by reference.

### FIELD OF THE INVENTION

This invention generally relates to a driver monitoring system for a vehicle.

### BACKGROUND

A known driver monitoring system for a vehicle disclosed in JP2003-112605A monitors a driver of a vehicle based on an image captured by an image capturing means that can be activated by means of a controlling means. The controlling means of the driver monitoring system determines whether or not a driver is looking aside or falling asleep based on the captured image for the purposes of performing a process for safety (i.e. safety process). Further, the controlling means stores an image captured by the image capturing means into a storing means, or determines whether or not a driver on a driver's seat is identical to a registered driver for the purposes of performing a process for theft prevention (i.e. antitheft process).

For example, when the controlling means determines that a driver is looking aside or falling asleep, the controlling means then alerts the driver by activating an alarm, for example, as the safety process. In addition, when the controlling means determines that a driver on the driver's seat is different from the registered driver, the controlling means then alarms the outside of a vehicle, for example, as the antitheft process.

According to the aforementioned driver monitoring system, a security setting means for activating an antitheft function and an intrusion sensor for detecting an intruder into a vehicle are provided. In cases where the intrusion sensor detects an intruder into a vehicle in a state in which an ignition switch is turned to OFF state and at the same time the antitheft function is activated by the security setting means, the controlling means performs the antitheft process by storing an image captured by the image capturing means into the storing means. Meanwhile, when the ignition switch is turned to ON state, the controlling means performs the safety process by determining whether or not a driver is looking aside or falling asleep on the basis of an image captured by the image capturing means.

The known controlling means of the driver monitoring system performs the antitheft process and the safety process separately, i.e. not simultaneously, by switching therebetween because of an issue of increase of heating value, performance level of a computer, and the like.

According to the aforementioned driver monitoring system, the antitheft process and the safety process are switched therebetween on the basis of ON/OFF status of the ignition switch. It may be thus possible that the safety process and the antitheft process are not accurately switched therebetween.

For example, in cases where the ignition switch remains in ON position at a time of a driver change or shopping, the antitheft process should be performed but actually the safety process is performed. In addition, a vehicle may be parked with the ignition switch in ON position at a time of a driver having a nap in a vehicle, and the like. At this time, the safety process is desired not to be performed so as not to alert the driver. However, the safety process may be performed.

Thus, a need exists for a driver monitoring system for a vehicle that can perform an antitheft process and a safety process in such a manner that the antitheft process and the safety process are appropriately switched therebetween.

### SUMMARY OF THE INVENTION

According to an aspect of the present invention, a driver monitoring system for a vehicle includes an image capturing means for capturing an image of a driver's seat, and a controlling means for performing a face identification determination, and an inattentive and drowsy driving determination of a driver based on an image captured by the image capturing means. The controlling means determines whether or not a driver on the driver's seat is a registered driver on the basis of an image captured by the image capturing means when a shifting means is in a parking position, and determines whether or not a driver is looking aside or falling asleep on the basis of an image captured by the image capturing means when the shifting means is in a shift position other than the parking position.

According to another aspect of the present invention, a driver monitoring system for a vehicle includes an image capturing means for capturing an image of a driver's seat, and a controlling means for performing a face identification determination, and an inattentive and drowsy driving determination of a driver based on an image captured by the image capturing means. The controlling means includes a face identification determining portion for determining whether or not an image captured by the image capturing means is identical to a driver registered beforehand, an inattentive and drowsy driving determining portion for determining whether or not a driver is looking aside or falling asleep on the basis of an image captured by the image capturing means, and a switching portion for switching between a processing performed by the face identification determining portion and a processing performed by the inattentive and drowsy driving determining portion. Further, the controlling means receives an information of a position of a shift lever so as to select by means of the switching portion the processing performed by the face identification determining portion when the shift lever is in the parking position, and to select by means of the switching portion the processing performed by the inattentive and drowsy driving determining portion when the shift lever is in a position other than the parking position.

### BRIEF DESCRIPTION OF THE DRAWINGS

The foregoing and additional features and characteristics of the present invention will become more apparent from the following detailed description considered with reference to the accompanying drawings, wherein:

FIG. 1 is a block diagram of a driver monitoring system for a vehicle according to first and second embodiments;

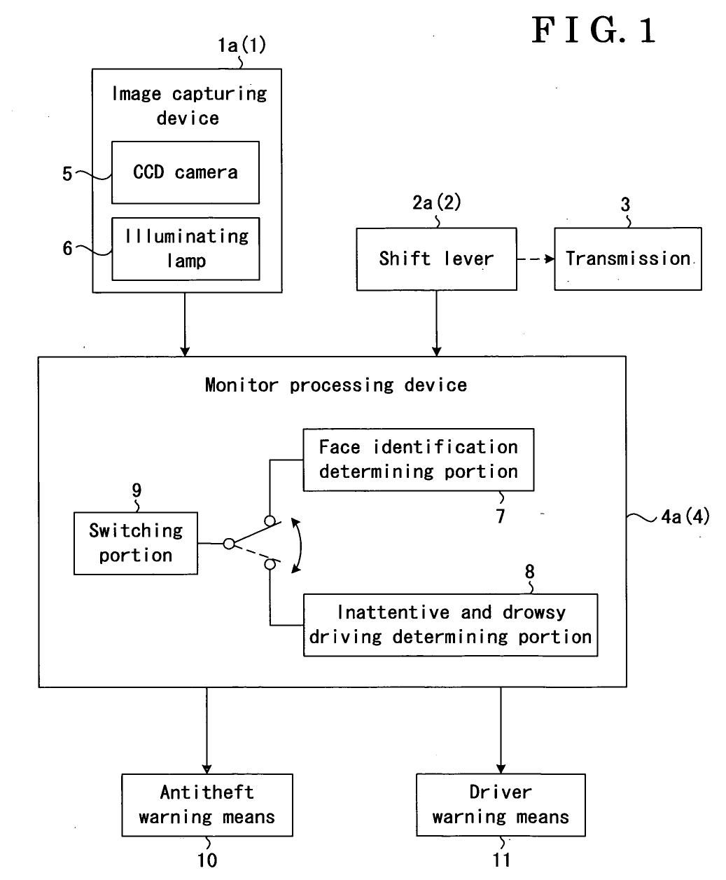

FIG. 2 is a flowchart showing an operation of the driver monitoring system according to the first embodiment of the present invention; and

FIG. 3 is a flowchart showing an operation of the driver monitoring system according to the second embodiment of the present invention.

### DETAILED DESCRIPTION

A first embodiment of the present invention is explained with reference to the attached drawings. A driver monitoring system for a vehicle according to the first embodiment includes an image capturing device 1a serving as an image capturing means 1 for capturing an image of a driver's seat, a shift lever 2a serving as a shifting means 2 that can be shifted to a parking position and the other positions, a transmission 3 for stopping a vehicle when the shift lever 2a is in a parking position and for driving a vehicle in response to a state of the shift lever 2a, and a monitor processing device 4a serving as a controlling means 4 for controlling an operation of the image capturing device 1a and the like.

The image capturing device la is fixed in a vehicle interior, and includes a CCD camera 5 for capturing an image of a face of a driver seated on a driver's seat, and an illuminating lamp 6 for illuminating a face of a driver. The illuminating lamp 6 is constituted, for example, by an infrared light-emitting diode. The image capturing device 1a outputs an image of a driver's face captured by the CCD camera 5 to the monitor processing device 4a. The image capturing device 1a is constantly powered so as to continuously capture an image of the driver's seat and send the captured image to the monitor processing device 4a.

The shift lever 2a can be shifted by an operation of a driver to a parking position and the other multiple positions such as a reverse position, a neutral position, a drive position and a second position.

The monitor processing device 4a includes a face identification determining portion 7 for determining whether or not a driver on the driver's seat is identical to a registered driver, an inattentive and drowsy driving determining portion 8 for determining whether or not a driver is looking aside or falling asleep on the basis of an image captured by the image capturing device 1a, and a switching portion 9 for switching between a state in which a processing by the face identification determining portion 7 is performed and a state in which a processing by the inattentive and drowsy driving determining portion 8 is performed, and the like.

The face identification determining portion 7 stores in a memory thereof an image of a driver's face registered beforehand, which is then compared to an image output from the image capturing device 1a to check if facial features between two images are identical to each other for the purposes of determining whether or not the driver seated on the driver's seat has been registered, i.e. the registered driver. A registration of a driver is conducted by capturing an image of the driver's face by the image capturing device 1a and then the captured image is input into the face identification determining portion 7 so as to be stored in the memory thereof.

The inattentive and drowsy driving determining portion 8 detects a darkest portion in an image output from the image capturing device 1a as an eyes position of a driver so as to detect a time-series change of the eyes position. The inattentive and drowsy driving determining portion 8 determines whether or not a driver is looking aside or falling asleep by detecting an open/closed status of eyes of a driver in a time-series manner. Precisely, when a closed state of the eyes of a driver lasts for a predetermined time, it is determined that the driver is falling asleep while it is determined that the driver is looking aside when a direction of the eyes or a face of the driver is different from a vehicle running direction in a state of the eyes open. The vehicle running direction is decided such that a detected information by a running direction detecting means (not shown) for detecting an angle of a steering, for example, is input into the monitor processing device 4a.

The switching portion 9 switches to a state in which the processing by the face identification determining portion 7 is performed when the shift lever 2a is in a parking position for the purposes of determining whether or not a driver on the driver's seat is the registered driver on the basis of an image captured by the image capturing device 1a. Further, the switching portion 9 switches to a state in which the processing by the inattentive and drowsy driving determining portion 8 is performed when the shift lever 2a is in a position other than the parking position for the purposes of determining whether or not a driver is looking aside or falling asleep on the basis of an image captured by the image capturing device 1a.

An input of an image captured by the image capturing device 1a and a power supply from a power supply electronic control unit, (i.e. ECU) are also provided to be switched between the face identification determining portion 7 and the inattentive and drowsy driving determining portion 8 by means of the switching portion 9. When the shift lever 2a is in the parking position, the switching portion 9 operates such that an image captured by the image capturing device 1a and a power supply of the power supply ECU are provided to the face identification determining portion 7. Meanwhile, when the shift lever 2a is in a position other than the parking position, the switching portion 9 operates such that an image captured by the image capturing device 1a and a power supply of the power supply ECU are provided to the inattentive and drowsy driving determining portion 8.

When it is determined that a driver seated on the driver's seat is not the registered driver on the basis of the processing by the face identification determining portion 7, the monitor processing device 4a alerts an outside of a vehicle by activating an antitheft warning means 10. Further, when it is determined that a driver seated on the driver's seat is looking aside or falling asleep on the basis of the processing by the inattentive and drowsy driving determining portion 8, the monitor processing device 4a alerts the driver by activating a driver warning means 11.

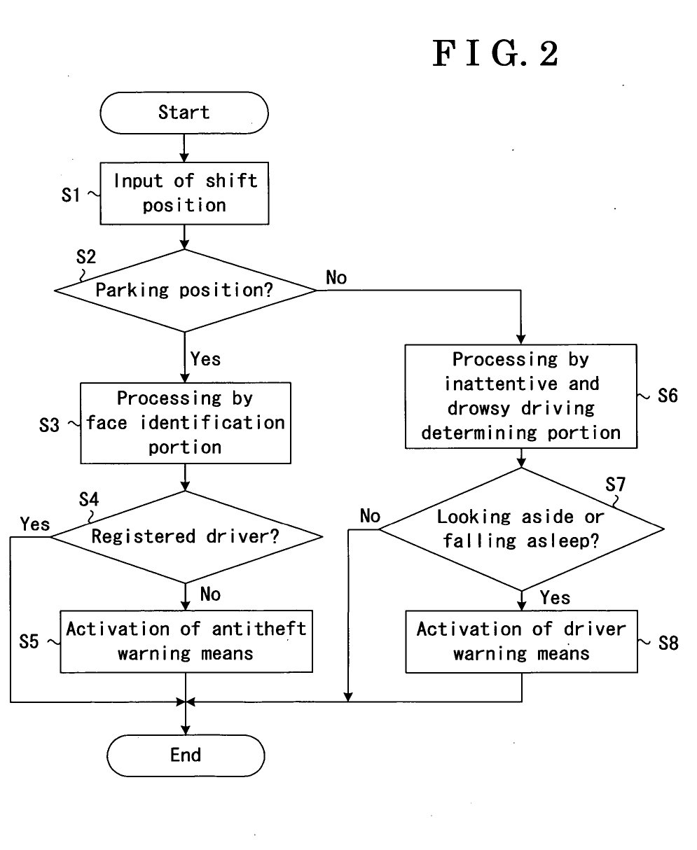

An operation of the monitor processing device 4a is explained with reference to a flowchart in FIG. 2. First, in S1, the monitor processing device 4a inputs a shift position status for indicating a position of the shift lever 2a. Then, when it is determined that the shift lever 2a is in the parking position in S2, the switching portion 9 switches to a state in which the processing by the face identification determining portion 7 is performed in S3 so as to determine whether or not a driver on the driver's seat is a registered driver. When it is determined that the driver on the driver's seat is not the registered driver in S4, the antitheft warning means 10 is activated in S5.

Meanwhile, when it is determined that the shift lever 2a is in a position other than the parking position in S2, the switching portion 9 switches to a state in which the processing by the inattentive and drowsy driving determining portion 8 is performed in S6 so as to determine whether or not a driver is looking aside or falling asleep. Then, when it is determined that the driver is looking aside or falling asleep in S7, the driver warning means 11 is activated in S8.

Next, a second embodiment is explained below. The second embodiment is different from the first embodiment only in conditions for switching between a state in which the processing by the face identification determining portion 7 is performed and a state in which the processing by the inattentive and drowsy driving determining portion 8 is performed. An explanation of the other structure is thus omitted.

According to the second embodiment, the switching portion 9 switches to a state in which the processing by the face identification determining portion 7 is performed when the shift lever 2a is in the parking position for the purposes of determining whether or not a driver on the driver's seat is the registered driver on the basis of an image captured by the image capturing device 1a. Further, the switching portion 9 switches to a state in which the processing by the inattentive and drowsy driving determining portion 8 is performed when the shift lever 2a is in a position other than the parking position and at the same time a parking brake is released for the purposes of determining whether or not a driver is looking aside or falling asleep on the basis of an image captured by the image capturing device 1a.

That is, it is further appropriately evaluated whether a vehicle is in a stopped state or in a running state by detecting a status of the parking brake in addition to a position of the shift lever 2a.

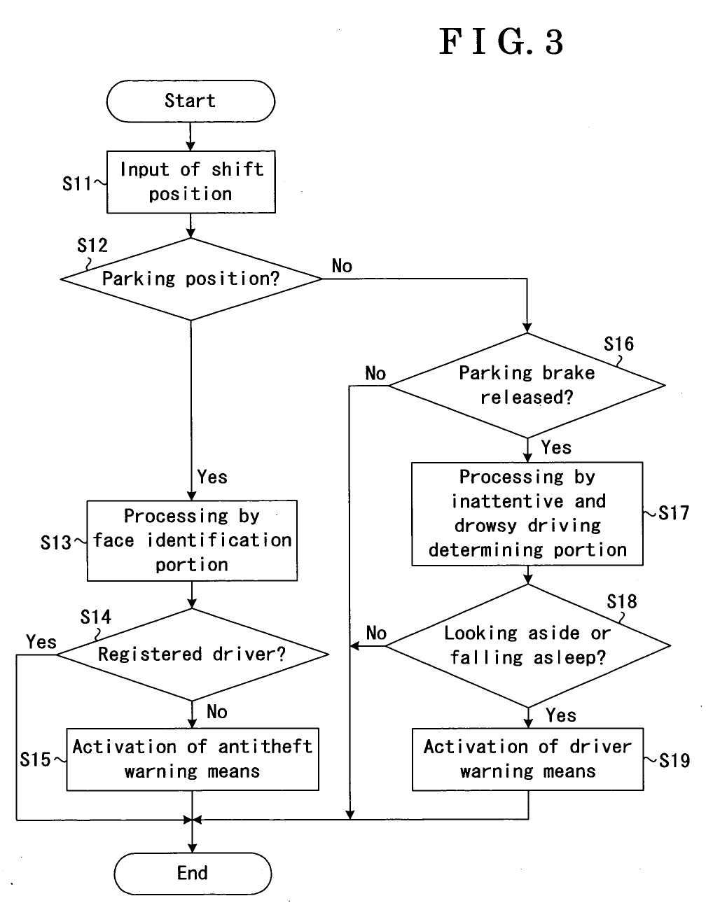

An operation of the monitor processing device 4a is explained with reference to a flowchart in FIG. 3. First, in S11, the monitor processing device 4a inputs a shift position status for indicating a position of the shift lever 2a. Then, when it is determined that the shift lever 2a is in the parking position in S12, the switching portion 9 switches to a state in which the processing by the face identification determining portion 7 is performed in S13 so as to determine whether or not a drivers on the driver's seat is a registered driver. When it is determined that the driver on the driver's seat is not the registered driver in S14, the antitheft warning means 10 is activated in S15.

Meanwhile, when it is determined that the shift lever 2a is in a position other than the parking position in S12 and then the parking brake is released in S16, the switching portion 9 switches to a state in which the processing by the inattentive and drowsy driving determining portion 8 is performed in S17 so as to determine whether or not a driver is looking aside or falling asleep. Then, when it is determined that the driver is looking aside or falling asleep in S18, the driver warning means 11 is activated in S19.

According to the aforementioned first and second embodiments, when the monitor processing device 4a determines that a driver on the driver's seat is not a registered driver, the antitheft warning means 10 is activated. However, instead, an alarm by means of a communication means, for example, may be possible for alerting an outside of a vehicle.

Further, according to the aforementioned first and second embodiments, when the monitor processing device 4a determines that a driver is looking aside or falling asleep, the driver warning means 11 is activated. However, instead, a driver's seat may be vibrated, for example, for alerting the driver.

Furthermore, according to the aforementioned embodiments, a vehicle state is categorized into a stopped state and a running state. Then, an antitheft process is required before the vehicle starts running. In addition, a safety process is required while the vehicle is actually running. Whether an engine of a vehicle is operated or not is less important in case of the vehicle stopped. During a normal operation of a vehicle, one of the conditions for identifying the stopped state and the running state of the vehicle is that whether or not the shift lever 2a is in the parking position or not. Thus, according to the aforementioned embodiments, the antitheft process and the safety process are switched therebetween on the basis of the position of the shift lever 2a. That is, when a vehicle is parked at a time of a driver change, shopping, and the like, or parked so that a driver has a nap in the vehicle, the driver mainly operates the shift lever 2a in the parking position. Even if an ignition switch is in ON state at that time, the antitheft process instead of the safety process may be performed.

According to the aforementioned structure, the antitheft process and the safety process may be switched on the basis of whether a vehicle is actually running or not, instead of ON/OFF status of the ignition switch as in the conventional structure. Thus, the further appropriate driver monitoring system may be provided.

Furthermore, according to the aforementioned structure, when a driver operates the shift lever 2a in a position other than the parking position and also releases the parking brake, the safety process is performed since it is highly possible that a vehicle is running at that time. As a result, the antitheft process and the safety process may be precisely switched therebetween.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the sprit of the present invention. Accordingly, it is expressly intended that all such variations, changes and equivalents which fall within the spirit and scope of the present invention as defined in the claims, be embraced thereby.

1. A driver monitoring system for a vehicle comprising:
an image capturing means for capturing an image of a driver's seat; and
a controlling means for performing a face identification determination, and an inattentive and drowsy driving determination of a driver based on an image captured by the image capturing means; wherein the controlling means determines whether or not a driver on the driver's seat is a registered driver on the basis of an image captured by the image capturing means when a shifting means is in a parking position, and determines whether or not a driver is looking aside or falling asleep on the basis of an image captured by the image capturing means when the shifting means is in a shift position other than the parking position.

2. A driver monitoring system according to claim 1, wherein the controlling means determines whether or not a driver is looking aside or falling asleep on the basis of an image captured by the image capturing means when the shifting means is in a position other than the parking position and a parking brake is released.

3. A driver monitoring system for a vehicle comprising:
an image capturing means for capturing an image of a driver's seat; and
a controlling means for performing a face identification determination, and an inattentive and drowsy driving determination of a driver based on an image captured by the image capturing means; the controlling means including a face identification determining portion for determining whether or not an image captured by the image capturing means is identical to a driver registered beforehand, an inattentive and drowsy driving determining portion for determining whether or not a driver is looking aside or falling asleep on the basis of an image captured by the image capturing means, and a switching portion for switching between a processing performed by the face identification determining portion and a processing performed by the inattentive and drowsy driving determining portion; the controlling means receiving an information of a position of a shift lever so as to select by means of the switching portion the processing performed by the face identification determining portion when the shift lever is in the parking position, and to select by means of the switching portion the processing performed by the inattentive and drowsy driving determining portion when the shift lever is in a position other than the parking position.

4. A driver monitoring system according to claim 3, wherein the image capturing means includes an illuminating means for illuminating a face of a driver in case of capturing an image of a driver's seat.

5. A driver monitoring system according to claim 4, wherein the illuminating means includes an infrared light-emitting diode.

6. A driver monitoring system according to claim 3, wherein the face identification determining portion stores in a memory thereof an image of a face of a driver registered beforehand.

7. A driver monitoring system according to claim 3, wherein the inattentive and drowsy driving determining portion determines whether or not a driver is looking aside or falling asleep by detecting an open/closed status of eyes of the driver, which is achieved by detecting a darkest portion in an image captured by the image capturing means as an eyes position of the driver so as to detect a time-series change of the eyes position.

8. A driver monitoring system according to claim 3, further comprising:
an antitheft warning means for alerting an outside of a vehicle when it is determined by the face identification determining portion that a driver on a driver's seat is not registered in a memory of the face identification determining portion.

9. A driver monitoring system according to claim 3, further comprising:
a driver warning means for alerting a driver when it is determined by the inattentive and drowsy driving determining portion that a driver is looking aside or falling asleep.

10. A driver monitoring system according to claim 3, wherein the processing by the inattentive and drowsy driving determining portion is performed when the shift lever is in a position other than the parking position and a parking brake of a vehicle is released.
